(19) United States
(12) Patent Application Publication
(10) Pub. No.: US 2015/0073695 A1
(43) Pub. Date: Mar. 12, 2015

(54) SYSTEM FOR ROUTE SCHEDULING, DRIVER ALERTS, AND CORRECTIVE ACTION BASED ON WEATHER GUIDANCE

(71) Applicants: Rory Groves, Minneapolis, MN (US); David Ladner, Chaska, MN (US)

(72) Inventors: Rory Groves, Minneapolis, MN (US); David Ladner, Chaska, MN (US)

(21) Appl. No.: 14/484,422

(22) Filed: Sep. 12, 2014

Related U.S. Application Data
(60) Provisional application No. 61/877,059, filed on Sep. 12, 2013.

(51) Int. Cl. G01C 21/00

(52) U.S. Cl. CPC G01C 21/00
USPC 701/400

(57) ABSTRACT

A route management system comprising dispatch operations; fleet management software; at least one onboard computing device; weather data; and a weather-fleet comparison method. More specifically, the system collects information about a place of departure, a place of arrival, a scheduled route, scheduled stops, and a weather forecast; compares the predicted weather forecast to the scheduled route; displays the weather forecast information to a driver and/or a dispatcher; determines if a new route or departure time should be scheduled; and, if a new route should be scheduled, displays the new route or departure time to the driver and/or the dispatcher.

### CROSS-REFERENCE TO RELATED APPLICATION

This application claims the benefit of U.S. Provisional Application No. 61/877,059, filed Sep. 12, 2013, titled SYSTEM FOR ROUTE SCHEDULING BASED ON WEATHER GUIDANCE.

### FIELD OF THE DISCLOSURE

The disclosed invention relates to a system used to predict weather, compare predicted weather to a scheduled route, and, if necessary based on the predicted weather, provide corrective route instructions to a driver.

### BACKGROUND OF THE INVENTION

Inclement weather has significant impacts on transportation. Studies have shown impacts such as reductions in roadway capacity, increased drivers' response and reaction times, and reduction in travel demands during inclement weather. Studies have also shown that incorporating inclement weather predictions into transportation operations and management can improve transportation system performances.

### SUMMARY OF THE INVENTION

The disclosed system can predict weather conditions based on where a transportation vehicle is located, as indicated by pre-planned navigational routes and GPS tracking. Drivers and dispatchers can be alerted to current inclement weather affecting the driver as well as inclement weather that may affect the driver several hours or days into the future based on the driver's position and route. By providing this weather prediction in advance, drivers and dispatchers can choose alternate routes, can delay departure, can adjust delivery timeframes, and can predict fuel economies.

As weather conditions constantly change, so does the weather forecast. The disclosed system can provide real-time continuous updates of weather conditions affecting future waypoints and destinations, so the driver or dispatcher may make en-route course adjustments based on the weather.

Drivers and dispatchers can be alerted to specific hazards the driver is approaching, such as severe thunderstorms, flash flooding, blizzards, large hail, tornadoes, and other weather phenomena that can directly threaten the safety of the driver or indirectly affect other individuals on the road. To increase safety and economy, the disclosed system can then provide corrective actions for the individual driver based on the type of weather.

### BRIEF DESCRIPTION OF THE DRAWINGS

FIG. 1 illustrates a flow diagram of one embodiment of the disclosed system.

FIG. 2 illustrates a fleet driver's dashboard according to one embodiment of the disclosed system.

FIG. 3 illustrates a dispatcher's dashboard according to one embodiment of the disclosed system.

FIG. 4 illustrates a message alert for a fleet driver according to one embodiment of the disclosed system.

FIG. 5 illustrates a message alert for a dispatcher according to one embodiment of the disclosed system.

FIG. 6 illustrates an initial route for a fleet driver according to one embodiment of the disclosed system.

FIG. 7 illustrates an alternate route for a fleet driver according to one embodiment of the disclosed system.

FIG. 8 illustrates an initial route for a fleet driver according to one embodiment of the disclosed system.

FIG. 9 illustrates an alternate route for a fleet driver according to one embodiment of the disclosed system.

FIG. 10 is a schematic block diagram depicting an example computing system used in accordance with one embodiment of the present invention.

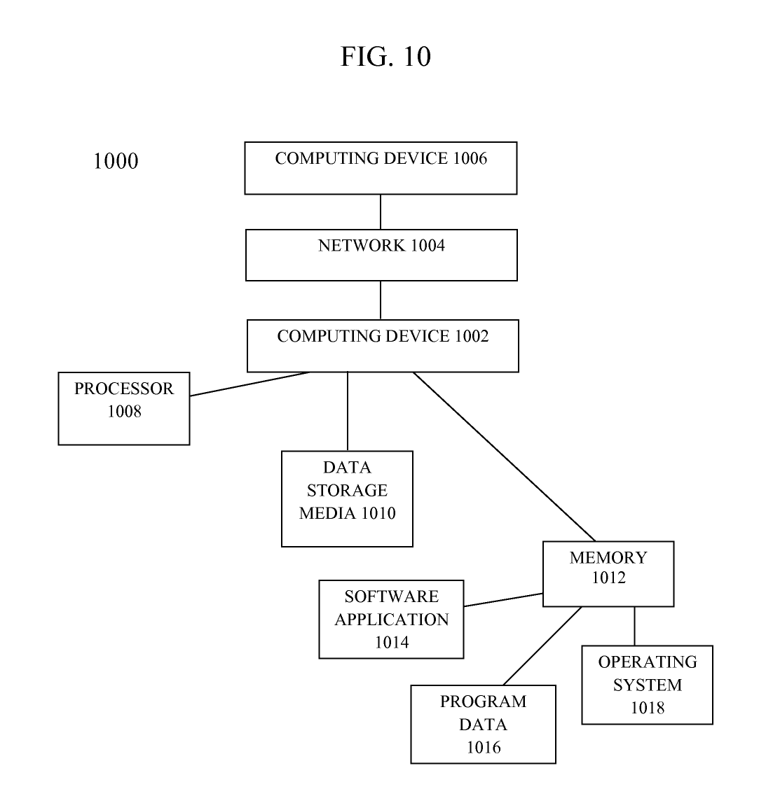

### DETAILED DESCRIPTION

Various user interfaces and embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover application or embodiments without departing from the spirit or scope of the claims attached hereto. Also, it is to be understood that the phraseology and terminology used herein are for the purpose of description and should not be regarded as limiting.

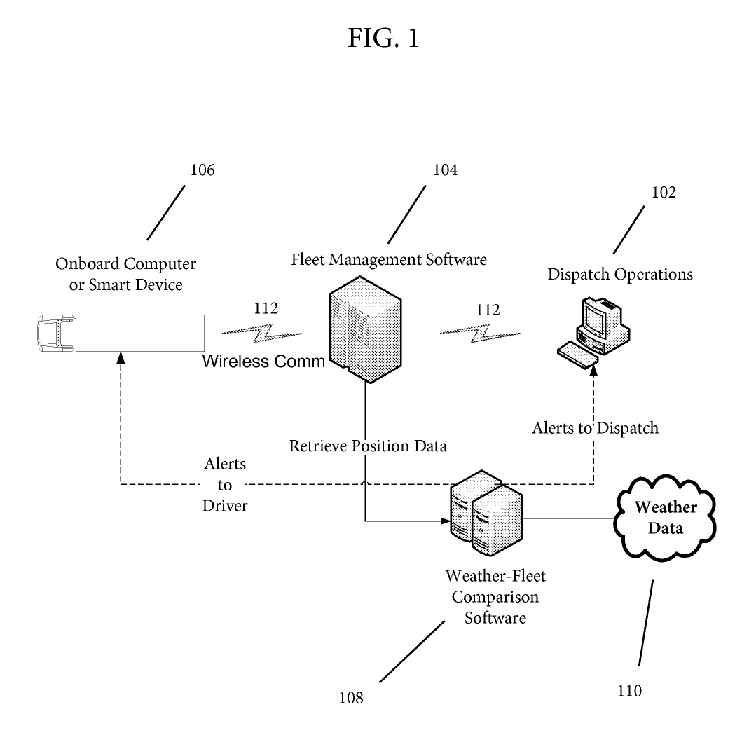

In one embodiment, the disclosed system includes dispatch operations 102, fleet management software 104, at least one onboard computer or smart device 106, weather-fleet comparison software 108, and weather data 110, as illustrated in FIG. 1. The system, or parts of it, can be coordinated using at least one application. In some embodiments, the application can be a downloadable application. For example, a fleet driver can use one variation of the application on a mobile device, such as a tablet, while a dispatcher can use a second variation of the application on a stationary computing device, such as a desktop computer. Alternatively, a stand-alone physical device can exist that already has all of the software and hardware features integrated into it and that accomplishes most or all of the processes in the described system.

Dispatch operations 102 includes dispatch software and employees (i.e., dispatchers) that run the operations control of a company involved in managing fleet operations. In some embodiments, the dispatch operations software can be specialized computer software that monitors the company's transportation assets.

Dispatchers can utilize the fleet management software 104 to communicate directly with fleet drivers. Communication can take place via wireless communication 112. For example, dispatchers can communicate to fleet drivers through onboard computers or smart devices 106 installed in the fleet driver's vehicle.

The onboard computer or smart device 106 can be installed in the fleet vehicle or carried by a fleet driver (for example, a smartphone, tablet, or any other device that runs an operating system such as, but not limited to, Windows, iOS, and Android) and can allow real-time messaging between the driver of the vehicle and the dispatcher by using the fleet management software 104. The onboard computer or smart device 106 can also provide the fleet driver with a visual presentation of route and weather data, as described below.

The weather-fleet comparison software 108 is capable of comparing fleet routes and positions against a database of inclement weather or expected inclement weather. Route-impacting weather alerts can be issued to appropriate parties, such as the driver and dispatchers. Additionally, the alerts can include suggested route modifications or travel times for the current route or suggested route. These suggestions can be automatically calculated by the weather-fleet comparison software 108 and issued to the driver and dispatchers. Alternatively, dispatchers can enter a suggested route change after receiving an alert and can communicate the suggested route change to the driver using the fleet management software 104.

Weather data 110 represents an aggregation of numerous sources of weather data including, but not limited to, government and private meteorological entities. More specifically, the weather data 110 represents a collection of data from computer programs that poll multiple Internet sources of weather on a scheduled basis (for example, every minute, every 5 minutes, every hour, etc.) depending on when each source is updated. An example source of weather data includes government Doppler radar stations that can indicate the presence of thunderstorms, heavy rain, tornadoes, or other severe weather. After the weather data 110 is collected, it is parsed and converted into a common format that is readable by the disclosed analysis programs. The analysis programs can collect information such as, but not limited to, the time the weather will reach the route, the time the weather will no longer affect the route, the type of weather, the movement of the weather (such as the direction and speed), and a long-form description. After analysis, the weather can be assigned a category of threat based on how it can impact the driver. For example, the weather data analysis can analyze the weather and compare it to the position and heading of the driver. It can determine that 18 MPH crosswinds may constitute a threat, but 18 MPH tailwinds would not.

In one embodiment, as illustrated in FIG. 1, dispatch operations 102 communicates to the driver's onboard computer or smart device 106 via the fleet management software 104, which can use wireless communication 112 to stay in constant contact with the driver. Information such as navigational routes, driver's GPS position, and other pertinent information can be delivered back and forth between the dispatcher and the driver using the fleet management software 104 and wireless communication 112.

Location information can be gathered various ways. In one embodiment, the fleet management software 104 can gather and provide GPS information. In another embodiment, a separate mobile application that coordinates all components of the disclosed system can include a GPS component. In a third embodiment, the onboard computer or smart device 106 used to enable communication between the driver and dispatcher can integrate with a separate GPS device, such as, but not limited to, a Garmin navigation device. The system could also employ other location-determination methods or technologies such as those using cell towers or sensors.

The weather prediction software 108 can receive constant updates as to the geographic position of fleet vehicles and use that data to determine if weather hazards exist for those geographic locations. If a weather impact is predicted, the weather prediction software 108 can issue an alert to the driver and to the dispatcher. The alert can be an audio alert or a visual alert, such as text. In addition to alerts, the weather prediction software 108 can suggest route modifications or alternate departure and layover times to help the driver avoid inclement weather. Further, if the driver is unable to avoid the weather hazard, the weather prediction software 108 can suggest corrective actions such as, but not limited to, decreasing speed and increasing the distance between vehicles.

As described above, the fleet driver and dispatcher can each have a different variation of a downloadable application that coordinates the disclosed system. For example, while the fleet driver and dispatcher can each have a dashboard that displays the above-described information in notification tabs, the dispatcher may have additional notification tabs or additional information in each notification tab because the dispatcher is concerned with weather affecting several drivers whereas the driver is only concerned about weather affecting his or her single route. Additionally, the dispatcher's variation can be mobile-based or desktop-based, while the fleet driver's variation is, in most embodiments, a mobile-based application.

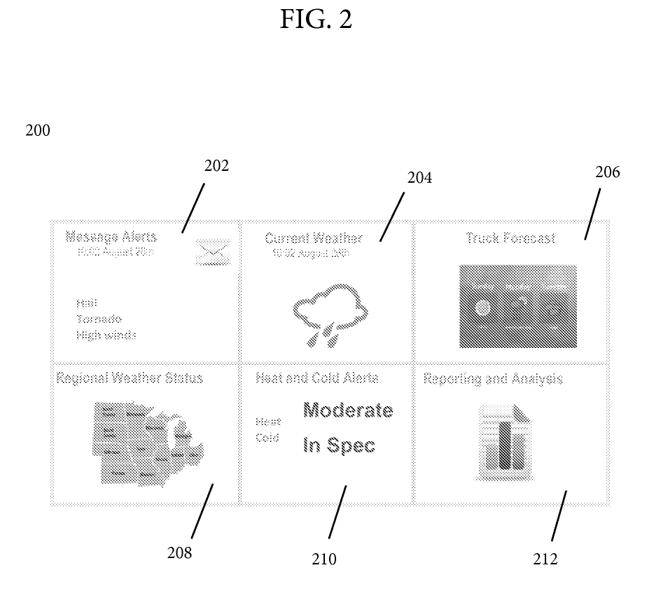

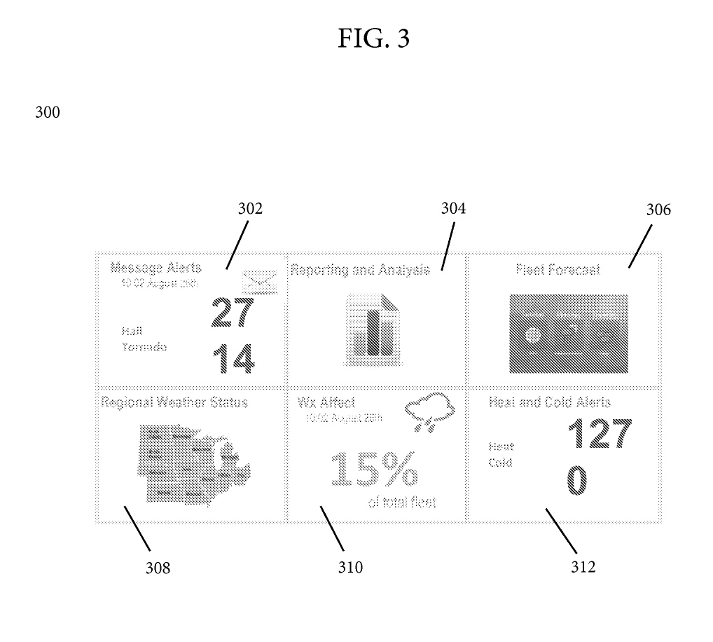

More specifically, as illustrated in FIGS. 2 and 3, the dashboard 200, 300 can include notification tabs such as, but not limited to, messages 202, 302, reporting and analysis 212, 304, forecast 206, 306, regional weather status 208, 308, and hot and cold alerts 210, 312. The fleet driver's dashboard 200 can include a current weather notification tab 204 and the dispatcher's dashboard 300 can include a Wx affect notification tab 310.

The fleet driver's dashboard 200, illustrated in FIG. 2, can utilize onboard computing equipment to display a comprehensive view of the fleet driver's current weather situation as it impacts his or her route. The fleet driver's dashboard 200 can include notification tabs such as, but not limited to, messages 202, current weather 204, truck forecast 206, regional weather 208, heat and cold alerts 210, and reporting and analysis 212. In one embodiment, the notification tabs have the ability to be laid out in a 2 by 3 or a 3 by 2 matrix depending on the number of notification tabs and whether the device is in a portrait or landscape mode.

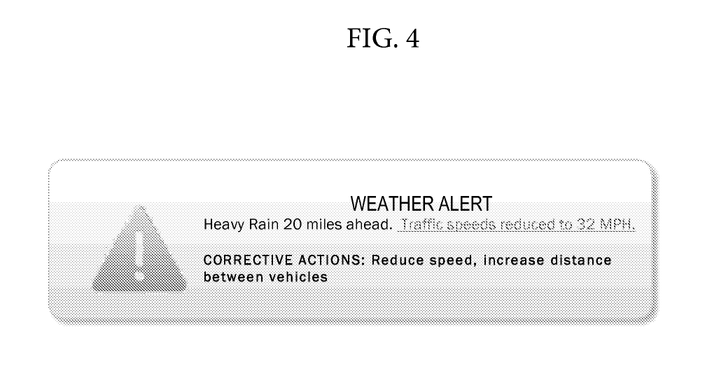

In some embodiments, the messages notification tab 202 can provide the fleet driver with advanced alerts to inclement weather that is likely to affect the fleet driver's route. A specific alert, an example of which is illustrated in FIG. 4, may pop-up or appear onscreen within the messages notification tab 202. The specific alert can include information such as, but not limited to, the weather type (for example, heavy rain), where the weather is predicted to occur (for example, 20 miles ahead), the actual impact on traffic (for example, traffic speeds reduced to 32 MPH), and potential corrective actions to take (for example, reduce speed and increase distance between vehicles). The messages notification tab 202 may be static or interactive, wherein the fleet driver can click on or select the tab and the screen will display more comprehensive information, such as prior messages, unopened messages, etc. If the tab is static, the information in the tab will dynamically populate as the weather situation changes.

In some embodiments, the weather notification tab 204 can provide the fleet driver with an overview of the current weather for his or her specific location. Current weather information can include, but is not limited to, outside temperature, humidity, wind speeds, wind direction, visibility, and active weather such as rain or snow. If there is inclement weather at the driver's current location, the weather notification tab 204 can trigger the message notification tab 202 to provide the fleet driver with an alternate route or it can suggest actions to take so as to avoid potential accidents or loss of cargo. For example, temperatures above 100 degrees Fahrenheit could trigger the application's message function to indicate to a driver of refrigerated cargo that the refrigeration function should be checked to ensure proper temperatures are being kept. The weather notification tab 204 may be static or interactive, wherein the fleet driver can click on or select the tab and the screen will display more comprehensive information. If the tab is static, the information in the tab will dynamically populate as the weather situation changes.

In some embodiments, if the fleet driver disregards a suggested alternate route or action, the onboard computer or smart device 106 can relay the fleet driver's lack of action back to the dispatcher through the fleet management software 104. For example, if the presence of heavy rain is detected and the application suggests that the driver should slow down, but the driver continues at a high speed on a crowded interstate, the driver's actions, or lack thereof, can be flagged and reported automatically to the dispatch operations 102.

In some embodiments, the truck forecast notification tab 206 can provide the fleet driver with a location-based future forecast of weather conditions based on the fleet driver's current route. The truck forecast notification tab 206 may be static or interactive, wherein the fleet driver can click on or select the tab and the screen will display more comprehensive information, such as precipitation percentages, specific locations where inclement weather is expected, etc. If the tab is static, the information in the tab will dynamically populate as the weather situation changes.

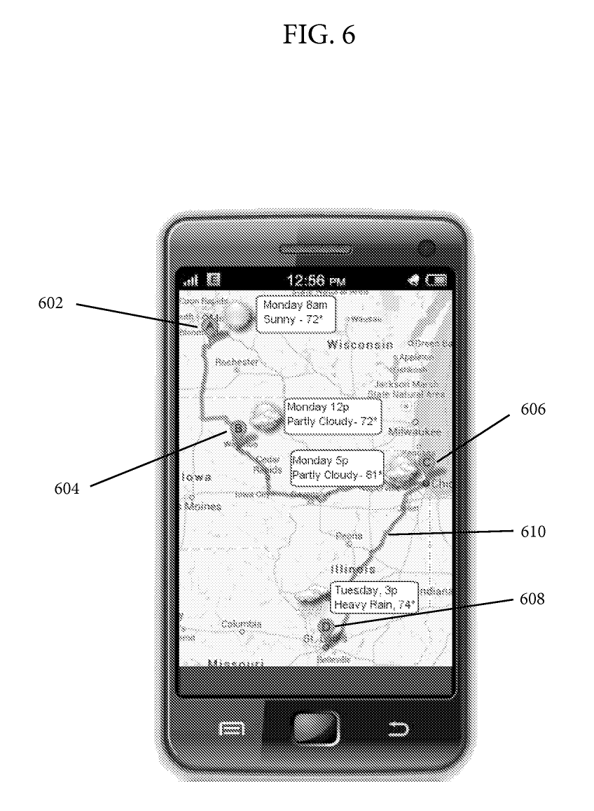

In some embodiments, the regional weather notification tab 208 can provide the fleet driver with an overview of regional weather so the fleet driver can see, at a glance, what weather impacts may possibly be affecting his or her route. The regional weather notification tab 208 may be static or interactive, wherein the fleet driver can click on or select the tab and the screen will display more comprehensive information, such as a map view, as illustrated in FIGS. 6-9. If the tab is static, the information in the tab will dynamically populate as the weather situation changes.

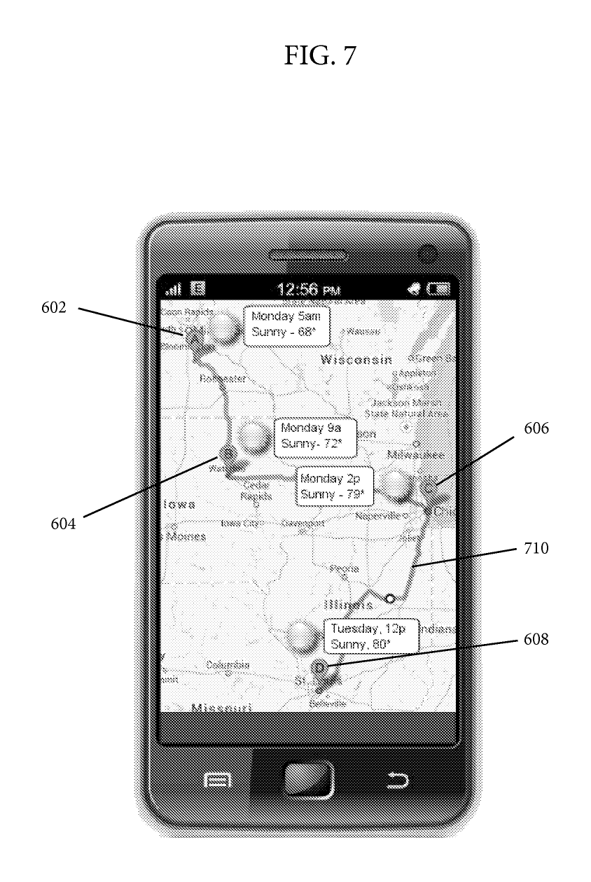

In some embodiments, the fleet driver can view the map view prior to his or her departure, as illustrated in FIGS. 6-9. The dispatcher may also be able to view a specific fleet driver's route view on the dispatcher's regional weather notification tab 308. For example, as illustrated in FIG. 6, if the fleet driver views the initial route 610 prior to departure, a map can pop up that shows the initial route 610 from the departure point 602 to the arrival point 608, including designated stopping points 604 and 606 and predicted weather at each point. This view enables the fleet driver to view a pre-planned route combined with the weather forecast on the fleet driver's onboard computer or smart device 106. In the initial route 610 depicted in FIG. 6 there are predicted severe thunderstorms at the arrival point 608, in St. Louis. Therefore, an alternate route 700, illustrated in FIG. 7, can be presented to the fleet driver. In this way, the disclosed system can ensure the fleet driver delivers his or her products on time and with minimal impact. The alternate route 710 suggests that the fleet driver depart three hours earlier from the departure point 602 and with the same stopping stops 604 and 606, but on a different route, to arrive at the arrival point 608 in St. Louis before the severe thunderstorms develop. In some embodiments, more than one alternative route can be displayed to the fleet driver along with predicted travel times and weather for each alternative route. The driver can then decide which route he or she would prefer to take.

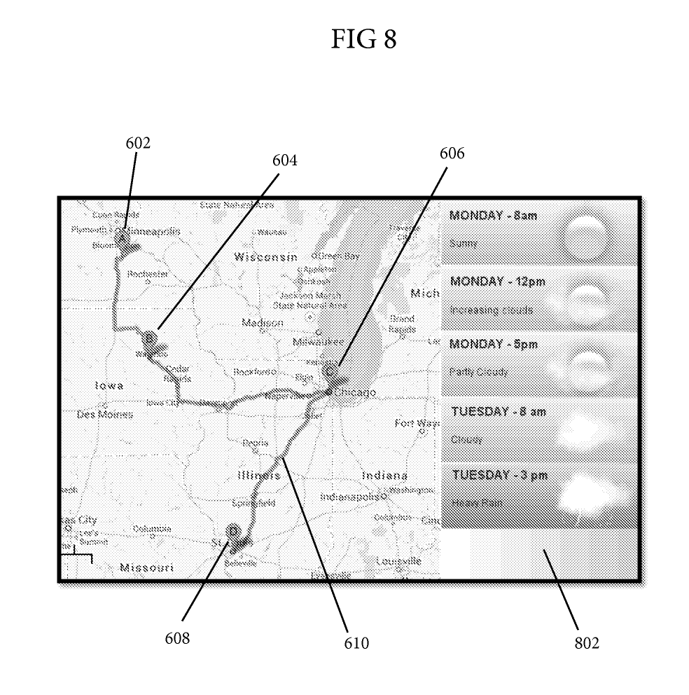

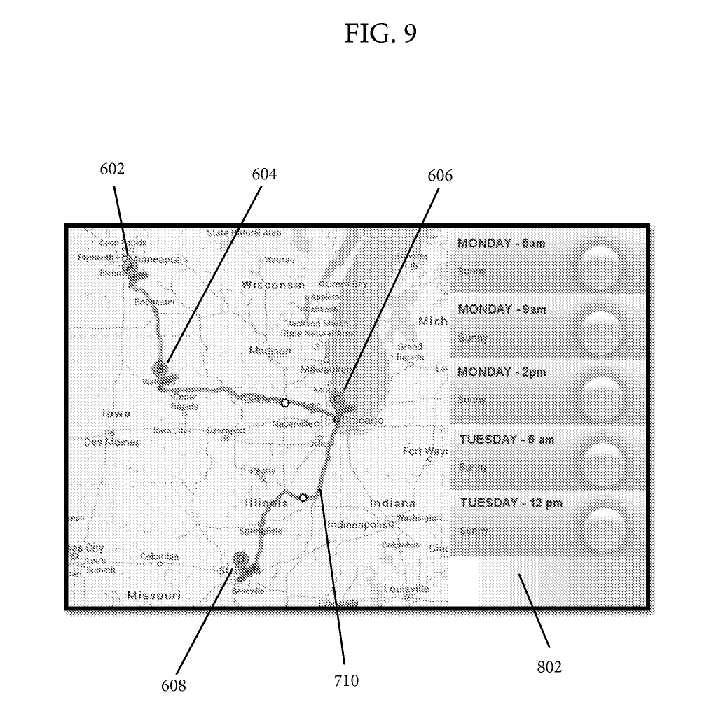

FIGS. 8 and 9 illustrate an alternate view of the information in FIGS. 6 and 7, wherein severe thunderstorms are predicted at 3:00 PM, when the driver is scheduled to arrive at the arrival point 608 in St. Louis on his or her initial route 610. However, the map view, in addition to showing the map and predicted weather at the departure point 602, stopping points 604 and 606, and arrival point 608, also illustrates additional forecast times 802. In some embodiments, the driver will see an hourly forecast, with the weather at each predicted hour coinciding with the predicted location of the driver at such time. In an alternative embodiment, the driver may only see the forecast for each specified stop. As illustrated, FIG. 8 displays the original route 610 with the predicted inclement weather at the arrival point 608, and FIG. 9 displays the alternate route 710 with predicted good driving weather throughout the entire trip.

In some embodiments, the heat and cold alerts notification tab 210 can indicate how weather conditions may be affecting the fleet driver's vehicle. For example, in extreme heat or cold conditions, the head and cold alert notification tab 210 may suggest to the fleet driver that he or she should delay his or her schedule or find an alternate route. The heat and cold alerts notification tab 210 may be static or interactive, wherein the fleet driver can click on or select the tab and the screen will display more comprehensive information, such as specific measures to take to prevent damage to goods, specific suggested routes and details about those routes, or specific times to depart at. If the tab is static, the information in the tab will dynamically populate as the weather situation changes.

In some embodiments, the reporting and analysis notification tab 212 provides the fleet driver with a report of the driver's location history, weather alerts history, and reporting capabilities based on previous positions and historical weather data. The reporting and analysis notification tab 212 may be static or interactive, wherein the fleet driver can click on or select the tab and the screen will display more comprehensive information. In some embodiments, the more comprehensive information can include a summary report available to the fleet driver, which can include information such as, but not limited to, miles driven for each trip, total miles driven over a period of time or number of trips, average miles driven per trip, maximum speed, minimum speed, average speed, hard breaking occurrences (frequency, date/time, etc.), frequency of lane departures, total number of stops, when and where re-routing occurred, fuel consumption, and number and frequency of delays. The report can be organized by type of weather of weather condition, day, time of day, length of trip, etc. This information can assist the fleet driver in making better-informed decisions about future weather events. If the tab is static, the information in the tab will dynamically populate as the weather situation changes.

The dispatcher's dashboard 300, illustrated in FIG. 3, can utilize a dedicated computer workstation and analytics to display a comprehensive view of the whole fleet and also to analyze predicted weather impacts for each fleet driver. The dispatcher's dashboard 300 can include notification tabs such as, but not limited to, messages 302, fleet forecast 306, regional weather 308, heat and cold alerts 310, reporting and analysis 304, and Wx affect 312. In one embodiment, the notification tabs have the ability to be laid out in a 2 by 3 or a 3 by 2 matrix depending on whether the device is in a portrait or landscape mode.

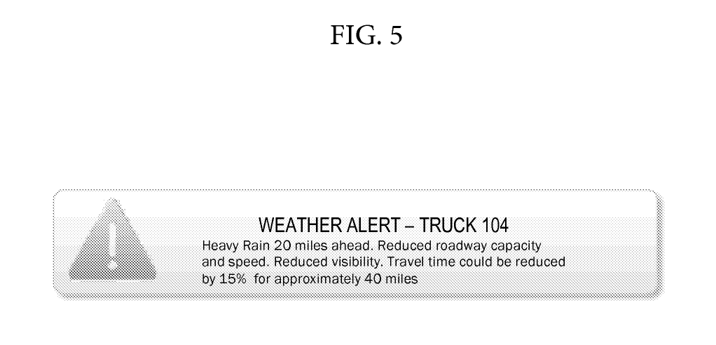

The messages notification tab 302 can provide the dispatcher with advanced alerts to inclement weather that is, or is likely, to affect any fleet vehicles. A specific alert, an example of which is illustrated in FIG. 5, may pop-up or appear onscreen. The specific alert can include information such as, but not limited to, the truck that is under the alert, the weather type (for example, heavy rain), where the weather is predicted to occur (for example, 20 miles ahead), the actual impact on traffic (for example, traffic speeds reduced to 32 MPH), impacts on travel time (for example, travel time reduced by 15% for approximately 40 miles), and other information (for example, a notice that there is reduced roadway capacity and speed and reduced visibility). One way for the system to obtain the traffic speed is to monitor speeds of nearby vehicles also using the disclosed system. Once the system has determined the traffic speed, it can relay the speed to the fleet driver, dispatcher, and any other fleet drivers heading in the same direction on the same or a similar route. The messages notification tab 302 may be static or interactive, wherein the dispatcher can click on or select the tab and the screen will display more comprehensive information, such as a list of all fleet trucks with current message notifications, wherein each listed truck can be further selected so the dispatcher can view the truck's specific weather-related information. If the tab is static, the information in the tab will dynamically populate as the weather situation changes.

The fleet forecast notification tab 306 can provide the dispatcher with a comprehensive, location-based, future forecast of weather conditions affecting every driver within the entire fleet. The fleet forecast notification tab 306 may be static or interactive, wherein the dispatcher can click on or select the tab and the screen will display more comprehensive information. If the tab is static, the information in the tab will dynamically populate as the weather situation changes.

The regional weather notification tab 308 can provide the dispatcher with an overview of regional or national weather so the dispatcher can see, at a glance, what weather impacts may possibly be affecting any of the drivers within the entire fleet. In some embodiments, the regional weather notification tab 308 may show a looping radar map. The regional weather notification tab 308 may be static or interactive, wherein the dispatcher can click on or select the tab and the screen will display more comprehensive information, such as an interactive map that the dispatcher can zoom in and out of, selectable icons for each fleet truck that is currently on the road, etc. If the tab is static, the information in the tab will dynamically populate as the weather situation changes.

The heat and cold alerts notification tab 312 can indicate to the dispatcher how weather conditions may be affecting all fleet vehicles. Dispatchers can be made aware of potential equipment failures in advance and schedule maintenance repairs at a fleet driver's next delivery checkpoint. In extreme heat or cold conditions, the dispatcher may want to delay scheduled departures or find alternate routes for any affected fleet vehicles to prevent damage to cargo in the truck. For example, temperatures above 100 degrees Fahrenheit could trigger the application's message function to indicate to the dispatcher who has a driver with refrigerated cargo that the dispatcher should tell the driver to check his or her refrigeration function to ensure proper temperatures are being kept. Extreme heat or cold can also affect fuel consumption, tire wear and tear, load safety, and idle time of the vehicle. These effects all result in excess costs and, therefore, the dispatcher may choose to delay departure of the vehicle until the weather improves or alter the route so that the bad weather can be avoided. The heat and cold alerts notification tab 312 may be static or interactive, wherein the dispatcher can click on or select the tab and the screen will display more comprehensive information, such as specific measures to take to prevent damage to goods, specific suggested routes and details about those routes, or specific times to depart at. If the tab is static, the information in the tab will dynamically populate as the weather situation changes.

The reporting and analysis notification tab 304 provides the dispatcher with the driving history and reporting capabilities for all fleet vehicles based on comprehensive location data and weather conditions. The reporting and analysis notification tab 304 may be static or interactive, wherein the dispatcher can click on or select the tab and the screen will display more comprehensive information. This information can include, but is not limited to, statistics on all vehicles in regard to miles driven for each trip, miles per gallon (MPG), total miles driven over a period of time or number of trips, average miles driven per trip, maximum speed, minimum speed, average speed, hard breaking occurrences (frequency, date/time, etc.), frequency of lane departures, total number of stops, when and where re-routing occurred, fuel consumption, and number and frequency of delays. This information can assist the dispatcher in making better-informed decisions on many areas of fleet management, including route planning, driver scheduling, and estimating fuel economies as it pertains to weather forecasts. If the tab is static, the information in the tab will dynamically populate as the weather situation changes.

The Wx affect notification tab 310 can provide the dispatcher with a quick view of how any inclement weather is impacting the entire fleet of vehicles. For example, in FIG. 3, weather is adversely affecting 15% of fleet vehicles currently in transit. The Wx affect notification tab 310 may be static or interactive, wherein the dispatcher can click on or select the tab and the screen will display more comprehensive information. If the tab is static, the information in the tab will dynamically populate as the weather situation changes.

The dispatcher's dashboard 300 can also display a dispatch map view, wherein the dispatcher can view all en route vehicles, can select individual vehicles, and can view any weather-related parameters in regards to those selected vehicles.

The foregoing systems and methods could be employed with autonomous, or semi-autonomous, cargo vehicles whereby weather alerts could result in direct, physical re-routing of the vehicle. In one embodiment, an unoccupied vehicle could be automatically controlled by software operation. In an alternative embodiment, a driver, or dispatcher, would monitor the disclosed system to evaluate proposed route changes and could override autonomous operation.

In some embodiments, the system described herein uses a computing system to carry out the various functions described herein. FIG. 12 is a schematic block diagram of an example computing system 1200. The example computing system 1200 includes at least one computing device 1202. In some embodiments the computing system 1200 further includes a communication network 1204 and one or more additional computing devices 1206 (such as a server).

The computing device 1202 can be, for example, located in a vehicle or in a place of business. In some embodiments, the computing device 1202 is a mobile device. The computing device 1202 can be a stand-alone computing device or a networked computing device that communicates with one or more other computing devices 1206 across a network 1204. The additional computing device(s) 1206 can be, for example, located remotely from the first computing device 1202, but configured for data communication with the first computing device 1202 across a network 1204.

In some examples, the computing devices 1202 and 1206 include at least one processor or processing unit 1208 and system memory 1212. The processor 1208 is a device configured to process a set of instructions. In some embodiments, system memory 1212 may be a component of processor 1208; in other embodiments system memory 1212 is separate from the processor 1208. Depending on the exact configuration and type of computing device, the system memory 1212 may be volatile (such as RAM), non-volatile (such as ROM, flash memory, etc.) or some combination of the two. System memory 1212 typically includes an operating system 1218 suitable for controlling the operation of the computing device 1202, such as the WINDOWSO operating systems or the OS X operating system, or a server. The system memory 1212 may also include one or more software applications 1214 and may include program data 1216.

The computing device 1202 may have additional features or functionality. For example, the computing device 1202 may also include additional data storage devices 1210 (removable and/or non-removable) such as, for example, magnetic disks, optical disks, or tape. Computer storage media 1210 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media 1210 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 1202. An example of computer storage media 1210 is non-transitory media.

In some examples, one or more of the computing devices 1202 and 1206 can be located in an establishment, such as vehicle or place of business. In other examples, the computing device 1202 can be a personal computing device that is networked to allow the user to access and utilize the system disclosed herein from a remote location, such as in a user's home, office or other location. In some embodiments, the computing device 1202 is a smart phone tablet, laptop computer, personal digital assistant, or other mobile device. In some embodiments, system operations and functions are stored as data instructions for a smart phone application. A network 1204 facilitates communication between the computing device 1202 and one or more servers, such as an additional computing device 1206, that hosts the system. The network 1204 may be a wide variety of different types of electronic communication networks. For example, the network 1204 may be a wide-area network, such as the Internet, a local-area network, a metropolitan-area network, or another type of electronic communication network. The network 1204 may include wired and/or wireless data links. A variety of communications protocols may be used in the network 1204 including, but not limited to, Wi-Fi, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 1206 is a Web server. In this example, the first computing device 1202 includes a Web browser that communicates with the Web server to request and retrieve data. The data is then displayed to the user, such as by using a Web browser software application. In some embodiments, the various operations, methods, and functions disclosed herein are implemented by instructions stored in memory. When the instructions are executed by the processor 1208 of the one or more computing devices 1202 or 1206, the instructions cause the processor 1208 to perform one or more of the operations or methods disclosed herein.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. A travel route management system comprising:
dispatch operations;
fleet management software;
at least one onboard computing device in a fleet vehicle;
weather data; and
a weather-fleet comparison method.

2. The travel route management system of claim 1, wherein a dispatcher can run dispatch operations using dispatch software.

3. The travel route management system of claim 1, wherein the fleet management software enables a driver and the dispatcher to communicate with each other.

4. The travel route management system of claim 1, wherein the onboard computing device enables the driver to communicate with the dispatcher using the fleet management software.

5. The travel route management system of claim 1, wherein the weather data is inputted into the system from a meteorological entity.

6. The travel route management system of claim 5, wherein the data is inputted on a scheduled basis.

7. The travel route management system of claim 1, wherein the weather-fleet comparison method is a method for managing a travel route and schedule and providing corrective actions to a driver based on a weather forecast comprising:
utilizing a networked computing device having a processing device and a memory device, the memory device storing information that, when executed by the processing device, causes the processing device to:
accept departure coordinates,
accept a scheduled departure time,
accept arrival coordinates,
accept a scheduled arrival time,
accept coordinates for scheduled stops,
accept a scheduled route,
accept the weather forecast data,
compare the scheduled route to the weather forecast data,
determine if weather threats to the scheduled route exist,
if weather threats to do exist, send an alert to the driver and the dispatcher, suggest corrective actions to the driver, and suggest an alternate route to avoid the weather threat.
